(19) United States
(12) Patent Application Publication
(10) Pub. No.: US 2015/0113412 A1
(43) Pub. Date: Apr. 23, 2015

(54) INTERACTIVE BUILD ORDER INTERFACE

(71) Applicant: Apple Inc., Cupertino, CA (US)

(72) Inventors: Eric S. Peyton, Naperville, IL (US); Evan S. Torchin, San Francisco, CA (US); James E. Tilton, Austin, TX (US); Ryan J. Poling, Pittsburgh, PA (US); Tamara L. Abell, Swissville, PA (US)

(73) Assignee: Apple Inc., Cupertino, CA (US)

(21) Appl. No.: 14/058,030

(22) Filed: Oct. 18, 2013

(51) Int. Cl. G06F 3/0482; G06F 3/0486

(52) U.S. Cl. CPC G06F 3/0482; G06F 3/0486
USPC 715/732

(57) ABSTRACT

An approach is presented for ordering and manipulating objects involved in a build on a slide of a presentation. For example, in certain embodiments, build effects may be grouped and moved or manipulated as groups within a build order list. In certain implementations, movement of build effects on the build order list may be facilitated by displaying one or more visual indicators conveying information about the order or properties of the build effects being moved.

### BACKGROUND

The present disclosure relates generally to the matching of objects on sequential screens, such as on sequential slides of a slideshow presentation.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the presentation of information to an audience, a presentation application implemented on a computer or other electronic device is commonly employed. For example, it is not uncommon for various types of public speaking, (such as lectures, seminars, classroom discussions, speeches, and so forth), to be accompanied by computer generated presentations that emphasize or illustrate points being made by the speaker. Such presentations may include music, sound effects, images, videos, text passages, numeric examples or spreadsheets, charts, graphs, or audiovisual content that emphasizes points being made by the speaker.

Typically, these presentations are composed of “slides” that are sequentially presented in a specified order. These slides may include a variety of graphical objects (such as videos, pictures, clipart, shapes, text, images, and so forth) and audio objects (such as sound clips or sound effects). These objects on a slide may be introduced, animated, or played at different times while the slide is being presented or in response to different cues while the slide is being presented. However, design and editing of such complex object builds on a slide slides may be difficult, particularly where multiple objects are provided on the slide or where complex or combined motion or other effects are implemented.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to techniques that simplify the ordering and manipulation of objects involved in a build on a slide of a presentation. For example, graphical indications may be provided as part of a drag-and-drop operation whereby an object or a group of objects may be selected and moved within the build order (which corresponds to the order in which objects are introduced, animated, or played on the slide). The graphical indications may provide feedback to a user about not only the reordering of the objects in the build, but also changes made to the start condition or other properties associated with the objects being reordered, such as whether the proposed move will change whether an object build operation is triggered by a user action (e.g., a mouse click) or automatically (e.g., based on an elapsed time). In this manner, both the ordering and properties of an object or group of objects in a build may be changed simultaneously, as opposed to separately specifying or changing a build order for the objects and subsequently defining the build properties for those objects.

### BRIEF DESCRIPTION OF THE DRAWINGS

Various aspects of this disclosure may be better understood upon reading the following detailed description and upon reference to the drawings in which:

FIG. 1 is a block diagram of an electronic device that may use the techniques disclosed herein, in accordance with aspects of the present disclosure;

FIG. 2 is a front view of a handheld device, such as an iPhone® by Apple Inc., representing an example of the electronic device of FIG. 1;

FIG. 3 is a front view of a tablet device, such as an iPad® by Apple Inc., representing an example of the electronic device of FIG. 1;

FIG. 4 is a perspective view of a notebook computer, such as a MacBook Pro® by Apple Inc., representing an example of the electronic device of FIG. 1;

FIG. 5 illustrates a edit mode screen of a presentation application in accordance with aspects of the present disclosure;

FIG. 6 depicts an example user interface in the form of a build inspector tool, in accordance with aspects of the present disclosure;

FIG. 7 depicts an example user interface in the form of a build order inspector panel including a build order list, in accordance with aspects of the present disclosure;

FIG. 8 depicts a close-up of a portion of a build order inspector panel depicting selection of a group of build operations, in accordance with aspects of the present disclosure;

FIG. 9 depicts the movement of the selected group of build operations of FIG. 8, in accordance with aspects of the present disclosure;

FIG. 10 depicts the movement of the selected group of build operations of FIG. 8 along with a drop indicator, in accordance with aspects of the present disclosure;

FIG. 11 depicts the movement of the selected group of build operations of FIG. 8 along with a second configuration of the drop indicator, in accordance with aspects of the present disclosure;

FIG. 12 depicts the completion of the movement of the selected group of build operations of FIG. 8, in accordance with aspects of the present disclosure;

FIG. 13 depicts a close-up of a portion of a build order inspector panel depicting selection of a further group of build operations, in accordance with aspects of the present disclosure;

FIG. 14 depicts the movement of the selected group of build operations of FIG. 13 along with a drop indicator, in accordance with aspects of the present disclosure;

FIG. 15 depicts the completion of the movement of the selected group of build operations of FIG. 13, in accordance with aspects of the present disclosure;

FIG. 16 depicts a close-up of a portion of a build order inspector panel depicting selection of a build operation, in accordance with aspects of the present disclosure;

FIG. 17 depicts the movement of the selected build operation of FIG. 16 along with a drop indicator, in accordance with aspects of the present disclosure;

FIG. 18 depicts the completion of the movement of the selected build operation of FIG. 16, in accordance with aspects of the present disclosure;

FIG. 19 depicts a close-up of a portion of a build order inspector panel depicting a further selection of a build operation, in accordance with aspects of the present disclosure;

FIG. 20 depicts the movement of the selected build operation of FIG. 19 along with a drop indicator, in accordance with aspects of the present disclosure;

FIG. 21 depicts the further movement of the selected build operation of FIG. 19 along with a drop indicator, in accordance with aspects of the present disclosure;

FIG. 22 depicts the further movement of the selected build operation of FIG. 19 along with a drop indicator, in accordance with aspects of the present disclosure;

FIG. 23 depicts the completion of the movement of the selected build operation of FIG. 19, in accordance with aspects of the present disclosure;

FIG. 24 depicts a close-up of a portion of a build order inspector panel depicting a further selection of a build operation, in accordance with aspects of the present disclosure;

FIG. 25 depicts the movement of the selected build operation of FIG. 24 as it is extracted from a group, in accordance with aspects of the present disclosure;

FIG. 26 depicts the further movement of the selected build operation of FIG. 24 along with a drop indicator, in accordance with aspects of the present disclosure;

FIG. 27 depicts the further movement of the selected build operation of FIG. 24 along with a drop indicator, in accordance with aspects of the present disclosure; and

FIG. 28 depicts the completion of the movement of the selected build operation of FIG. 24, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The disclosure is generally directed to interfaces for specifying or manipulating a build order of objects on a slide of a slideshow presentation. In one implementation, a graphical interface is provide by which a user may select an object or group of objects in a build and reorder those objects within the build while simultaneously (i.e., as part of the same step or operation) changing or setting one or more properties, such as a start condition, of the objects being moved. Such an approach is in contrast to approaches where separate operations are performed to change the build order and to change one or more build properties of the objects, such as the trigger that invokes a build action to be performed when the slide is displayed.

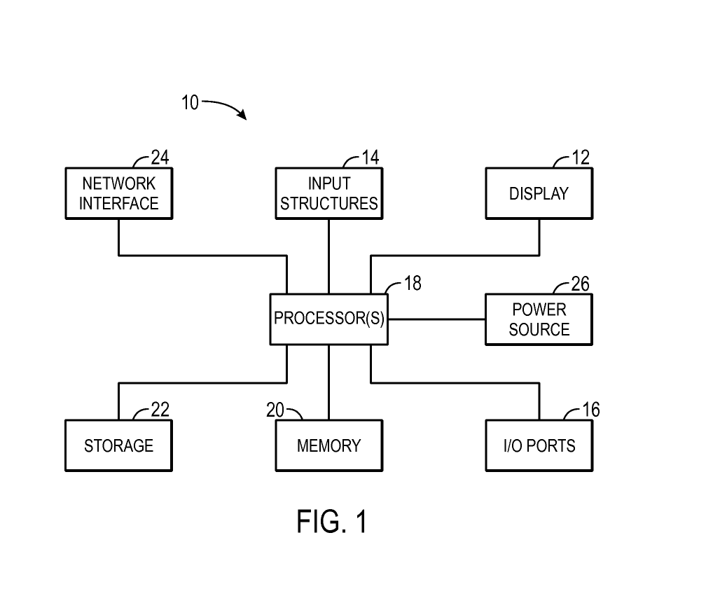

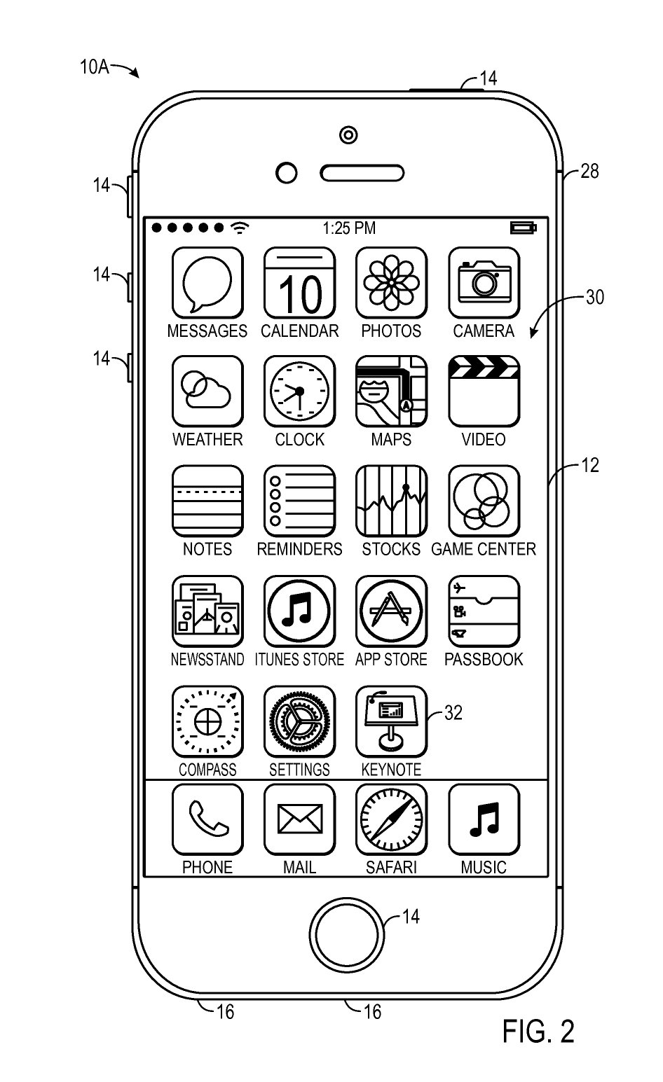

A variety of suitable electronic devices may employ the techniques described herein when executing or interacting with a presentation application. FIG. 1, for example, is a block diagram depicting various components that may be present in a suitable electronic device 10 that may be used in the implementation of the present approaches. FIGS. 2, 3, and 4 illustrate example embodiments of the electronic device 10, depicting a handheld electronic device, a tablet computing device, and a notebook computer, respectively.

Turning first to FIG. 1, the electronic device 10 may include, among other things, a display 12, input structures 14, input/output (I/O) ports 16, one or more processor(s) 18, memory 20, nonvolatile storage 22, a network interface 24, and a power source 26. The various functional blocks shown in FIG. 1 may include hardware elements (including circuitry), software elements (including computer code stored on a non-transitory computer-readable medium) or a combination of both hardware and software elements. It should be noted that FIG. 1 is merely one example of a particular implementation and is intended to illustrate the types of components that may be present in the electronic device 10. Indeed, the various depicted components (e.g., the processor(s) 18) may be separate components, components of a single contained module (e.g., a system-on-a-chip device), or may be incorporated wholly or partially within any of the other elements within the electronic device 10. The components depicted in FIG. 1 may be embodied wholly or in part as machine-readable instructions (e.g., software or firmware), hardware, or any combination thereof.

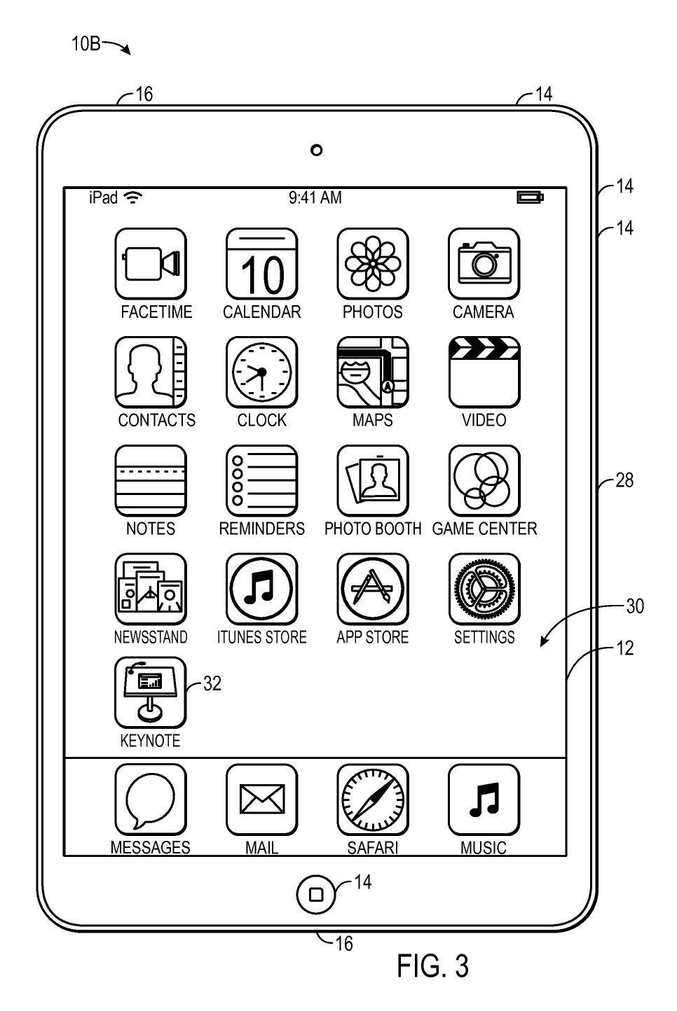

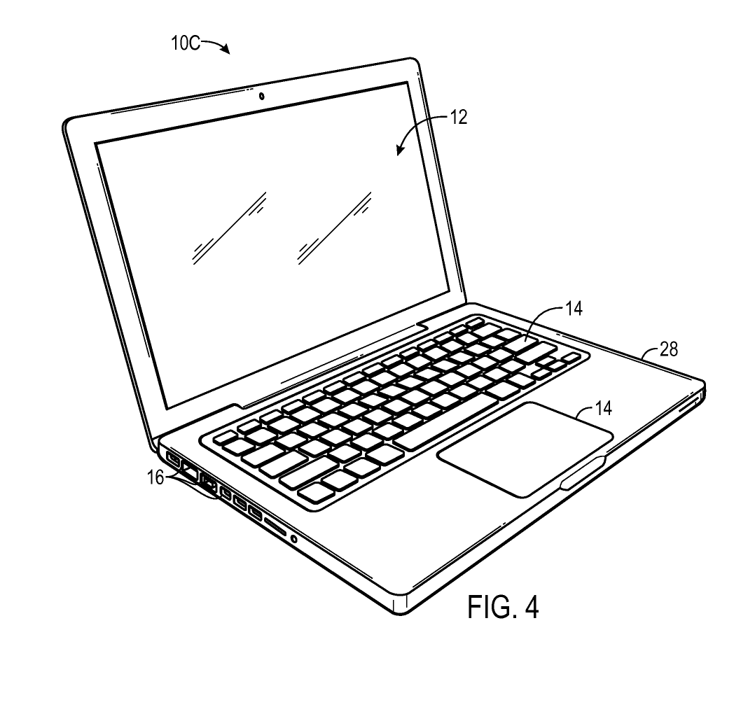

By way of example, the electronic device 10 may represent a block diagram of the handheld device depicted in FIG. 2, the tablet computing device depicted in FIG. 3, the notebook computer depicted in FIG. 4, or similar devices, such as desktop computers, televisions, and so forth. In the electronic device 10 of FIG. 1, the display 12 may be any suitable electronic display used to display image data (e.g., a liquid crystal display (LCD) or an organic light emitting diode (OLED) display). In some examples, the display 12 may represent one of the input structures 14, enabling users to interact with a user interface of the electronic device 10. In some embodiments, the electronic display 12 may be a MultiTouch™ display that can detect multiple touches at once. Other input structures 14 of the electronic device 10 may include buttons, keyboards, mice, trackpads, and the like. The I/O ports 16 may enable electronic device 10 to interface with various other electronic devices.

The processor(s) 18 and/or other data processing circuitry may execute instructions and/or operate on data stored in the memory 20 and/or nonvolatile storage 22. The memory 20 and the nonvolatile storage 22 may be any suitable articles of manufacture that include tangible, non-transitory computer-readable media to store the instructions or data, such as random-access memory, read-only memory, rewritable flash memory, hard drives, and optical discs. By way of example, a computer program product containing the instructions may include an operating system (e.g., OS X® or iOS by Apple Inc.) or an application program (e.g., Keynote® by Apple Inc.).

The network interface 24 may include, for example, one or more interfaces for a personal area network (PAN), such as a Bluetooth network, for a local area network (LAN), such as an 802.11x Wi-Fi network, and/or for a wide area network (WAN), such as a 4G or LTE cellular network. The power source 26 of the electronic device 10 may be any suitable source of energy, such as a rechargeable lithium polymer (Li-poly) battery and/or an alternating current (AC) power converter.

As mentioned above, the electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). FIG. 2 depicts a front view of a handheld device 10A, which represents one embodiment of the electronic device 10. The handheld device 10A may represent, for example, a portable phone, a media player, a personal data organizer, a handheld game platform, or any combination of such devices. By way of example, the handheld device 10A may be a model of an iPod® or iPhone® available from Apple Inc. of Cupertino, Calif.

The handheld device 10A may include an enclosure 28 to protect interior components from physical damage and to shield them from electromagnetic interference. The enclosure 28 may surround the display 12, which may display a graphical user interface (GUI) 30 having an array of icons 32. By way of example, one of the icons 32 may launch a presentation application program (e.g., Keynote® by Apple Inc.). User input structures 14, in combination with the display 12, may allow a user to control the handheld device 10A. For example, the input structures 14 may activate or deactivate the handheld device 10A, navigate a user interface to a home screen, navigate a user interface to a user-configurable application screen, activate a voice-recognition feature, provide volume control, and toggle between vibrate and ring modes. Touchscreen features of the display 12 of the handheld device 10A may provide a simplified approach to controlling the presentation application program. The handheld device 10A may include I/O ports 16 that open through the enclosure 28. These I/O ports 16 may include, for example, an audio jack and/or a Lightning® port from Apple Inc. to connect to external devices. The electronic device 10 may also be a tablet device 10B, as illustrated in FIG. 3. For example, the tablet device 10B may be a model of an iPad® available from Apple Inc.

In certain embodiments, the electronic device 10 may take the form of a computer, such as a model of a MacBook®, MacBook® Pro, MacBook Air®, iMac®, Mac® mini, or Mac Pro® available from Apple Inc. By way of example, the electronic device 10, taking the form of a notebook computer 10C, is illustrated in FIG. 4 in accordance with one embodiment of the present disclosure. The depicted computer 10C may include a display 12, input structures 14, I/O ports 16, and a housing 28. In one embodiment, the input structures 14 (e.g., a keyboard and/or touchpad) may be used to interact with the computer 10C, such as to start, control, or operate a GUI or applications (e.g., Keynote® by Apple Inc.) running on the computer 10C.

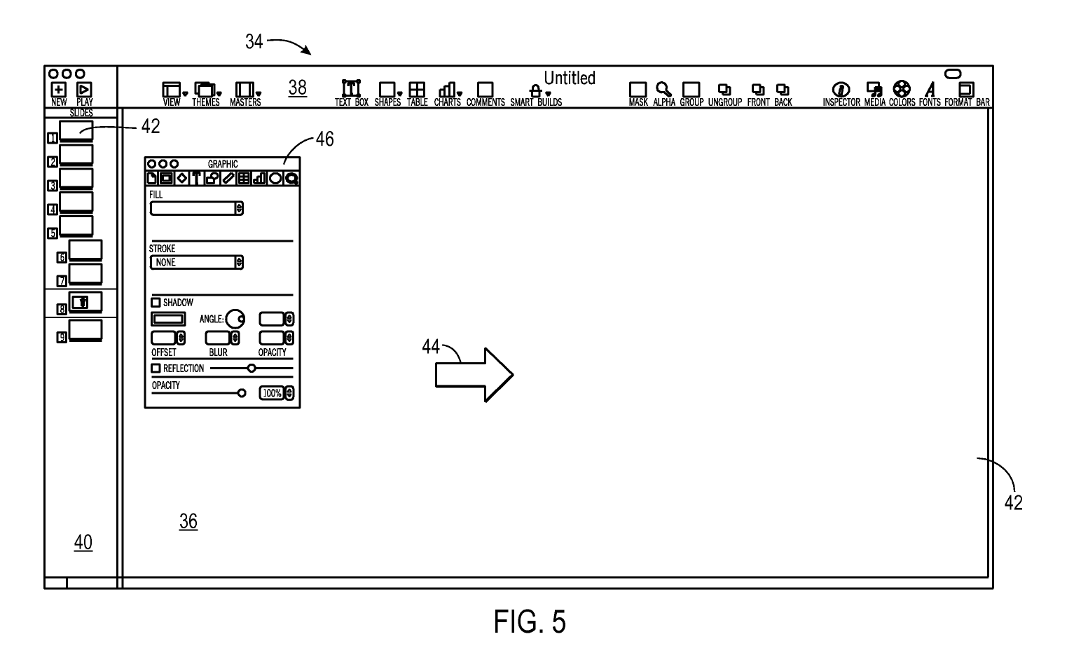

With the preceding in mind, a variety of computer program products, such as applications or operating systems, may use or implement the techniques discussed below to enhance the user experience on the electronic device 10. Indeed, any suitable computer program product that provides for the display and manipulation of objects in a work space, such as on a slide or slide canvas, may employ some or all of the techniques discussed below. For instance, the electronic device 10 may store and run a presentation program 34 (e.g., Keynote® from Apple Inc.), a screen of which is shown in FIG. 5. The presentation application may be stored as one or more executable routines (which may encode and implement the actions described below) in memory and/or storage (FIG. 1). These routines, when executed, may cause screens as discussed herein to be displayed on a screen of the electronic device or in communication with the electronic device and may likewise provide a build order interface and functionality as discussed herein.

With this in mind, the presentation application 34 shown in FIG. 5 may provide multiple modes of operation, such as an edit mode and a presentation mode. In FIG. 5, the presentation application 34 is shown in the edit mode. In the edit mode, the presentation application may provide a convenient and user-friendly interface for a user to add, edit, remove, or otherwise modify the slides of a slide show. To this end, the presentation program 34 may include three panes: a canvas 36, a toolbar 38, and a slide organizer 40. The canvas 36 may display a currently selected slide 42 from among the slide organizer 40. A user may add content to the canvas 36 using tool selections from the toolbar 38. Among other things, this content may include objects 44 such as text boxes, images, shapes, and/or video objects.

As used herein, a “slide” should be understood to refer to a discrete unit of a presentation, which may or may not be ordered or sequential in nature. Such a slide, therefore, may be understood to function as a container for a set of objects (as discussed below) that together convey information about a topic of a presentation. For example, each slide may contain or include different types of objects that explain or describe a concept to which the slide is directed. Further, because a slide may contain multiple objects, a slide may have an associated z-ordering of those objects as they are displayed on the slide. That is, to the extent that objects on the slide may overlap or interact with one another, they may be ordered or layered with respect to a viewer such that some objects are on top of or beneath other objects as they appear on the slide. In this way, a slide may not only have a width and length associated with it, but also a depth.

Further, as used herein, the term “object” may be understood to refer to any discretely editable component on a slide of a presentation. That is, something that can be added to a slide and/or be altered or edited on the slide, such as to change its location, orientation, or size or to change its content, may be described as an object. Examples, of objects may include, but are not limited to, text or number objects, image objects, video objects, chart or graph objects, shape objects, audio objects, and so forth. For example, a graphic, such as an image, a photo, a shape, a line drawing, clip-art, a chart, a table, or a graph that may be provided on a slide, may constitute an object. Likewise, a character or string of characters (text or numbers) may constitute an object. Likewise, an embedded video and/or audio clip may also constitute an object that is a component of a slide. Therefore, in certain embodiments, characters and/or character strings (alphabetic, numeric, and/or symbolic), image files (.jpg, .bmp, .gif, .tif, .png, .cgm, .svg, .pdf, .wmf, and so forth), video files (.avi, .mov, .mp4, .mpg, .qt, .rm, .swf, .wmv, and so forth) and other multimedia files or other files in general may constitute “objects” as used herein. In certain graphics processing contexts, the term “object” may be used interchangeably with terms such as “bitmap” or texture”.

When in the edit mode, the user may assign animations or other effects to the objects on a slide, such as by designing a build for the objects on the slide that governs the appearance and animation of the objects when the slide is presented. For example, while a slide is being shown, the objects on the slide may, in accordance with the build, be animated to appear, disappear, move, play (in the context of a video or audio object), or otherwise change appearance in response to automated or user provided cues (such as a mouse click or an automated sequence).

Once the slides of a presentation are designed in the edit mode, the presentation may be played in the presentation mode by displaying one or more slides in sequence for viewing by an audience. In some embodiments, the presentation application may provide a full-screen presentation of the slides in the presentation mode, including any animations, transitions, or other properties defined for each object within the slides.

The order or sequence of the slides in a presentation or slideshow is relevant in that the information on the slides, typically conveyed by the objects placed on the respective slides, is generally meant to be viewed in a specified order and may build upon itself, such that the information on later slides is understandable in the context of information provided on preceding slides. That is, there is typically a narrative or explanatory flow associated with the ordering or sequence of the slides. As a result, if presented out of order, the information on the slides may be unintelligible or may otherwise fail to properly convey the information contained in the presentation. This should be understood to be in contrast to more simplistic or earlier usages of the term “slide” and “slideshow” where what was typically shown was not a series of multimedia slides containing sequentially ordered content, but projected photos or images which could typically be displayed in any order without loss of information or content.

With the preceding discussion in mind, the depicted example screen shown in FIG. 5 includes three panes: a slide canvas 36, a toolbar 38, and a slide organizer 40 for creating and editing various aspects of a slide of a presentation. With these panes, a user may select a slide of a presentation, add and/or edit the contents of a slide, and animate or add effects related to the contents of a slide. It should be understood that the size of each pane is merely illustrative, and that the relative size of each pane may vary or be adjusted by a user.

The slide organizer 40 may display a representation of each slide of a presentation that is being generated or edited. The slide representations may take on a variety of forms, such as an outline of the text in the slide or a thumbnail image of the slide. The slide organizer 40 may allow the user to organize the slides prepared using the application. For example, the user may determine or manipulate the order in which the slides are presented by dragging a slide representation from one relative position to another. As illustrated in FIG. 5, the slide representations in the slide organizer 40 may be indented or otherwise visually set apart for further organizational clarity.

Selecting a slide representation in the slide organizer 40 may result in the presentation application displaying the corresponding slide (e.g., slide 42) on the canvas 36. The selected slide 42 may include one or more suitable objects 44 such as, for example, text, images, graphics, video, or any other suitable object. A user may add or edit features or properties of the selected slide 42 when displayed on the slide canvas 36. For example, a user may edit settings or properties associated with the selected slide 42 (e.g., the slide background or template) on the canvas 36 or may edit the location, orientation, size, properties, and/or animation of objects (e.g., object 44) in the selected slide. The user may select a different slide to be displayed for editing on slide canvas 36 by selecting a different slide representation from the slide organizer 40.

In the depicted implementation, a user may customize objects 44 associated with the slide 42 or the properties of the slide 42 using various tools provided by the presentation application 34 in association with the canvas 36. For example, the toolbar 38 may provide various icons that activate respective tools and/or functions that may be used in creating or editing the slide 42. For example, the toolbar 38 may include an icon that, when selected, activates a build tool, as discussed herein, that allows one or more objects (e.g., images, tables, videos, etc.) to be selected and/or grouped and incorporated into a build associated with the slide, as discussed herein.

In some embodiments, the presentation application 34 may allow a control window 46 to be opened or displayed. The presentation application 34 may display the control window 46 automatically (e.g., based on the presentation application context) or in response to a user instruction (e.g., in response to a user instruction to display options related to one or more selected objects). The control window 46 may be moved, resized, and/or minimized/maximized independently of the panes 36, 38, and 40 (e.g., as an overlaid window). The control window 46 may provide one or more user input mechanisms of any suitable type, such as drop down menus, radio buttons, sliders, and so forth. The options available from control window 46 may vary based on a tool selected in toolbar 38 or by a type of object(s) 44 selected on the slide 42. For example, the control window 46 may provide different respective options if a table, video, graphic, or text is selected on the slide 42 or if no object 44 is selected. It should be understood that although only one control window 46 is shown in FIG. 5, the presentation application 34 may include any suitable number of control windows 46.

For example, in one implementation an example of a control window 46 may include a build tool or window used to generate or edit builds associated with a slide. In particular, in some embodiments, a user may animate, transform, play (in the context of an audio or video object), or otherwise apply an action to one or more objects 44 in a slide of a presentation. A slide may contain various textual, audio, or graphical elements that may be introduced, played, or animated in incremental or step-wise builds. For instance, a slide may list a number of textual elements provided as bullet points, but each bullet point may be introduced as a different build of the slide, so that a time interval or user input (e.g., mouse click) causes an animation which results in the next build of the slide being displayed. In this way, the slide may be constructed so that it initially appears with a title but no bullet points, then a series of builds each result in the introduction and display of another bullet point on the slide until the steps are complete and the next slide is displayed. Similarly, a slide may include discrete builds in which one or more graphical or textual elements are animated (moved, rotated, scaled, faded in, faded out, and so forth) at each build. Thus, as used herein, it should be understood that the term slide should be understood as encompassing a slide and any or all of the build permutations of that slide, i.e., the slide after build effect 1, build effect 2, and so forth.

With this in mind and returning to the discussion of the edit mode of the presentation application, a user may invoke a build mode via a respective icon on the toolbar 38 or via a button or control in another window or pane. Such a build mode may allow the user to order or assign one or more actions or effects to an object or objects 44 displayed on the slide when the slide is displayed during a presentation. For example, the user may define the manner and time in which an object 44 is introduced or removed from view as part of a build, i.e., the build in of the object 44 and the build out of the object 44. Further, the user may assign a sequence of actions or effects applied to the objects 44 while on the slide such that the actions are implemented to the object 44 via different steps or builds of the slide when the slide is displayed in a presentation. In this way a sequence of actions, such as motion, rotation, playing a video or sound clip, as well as changes to color opacity, size and so forth of displayed objects, may be applied to objects 44 on the slide when the slide is displayed in a presentation.

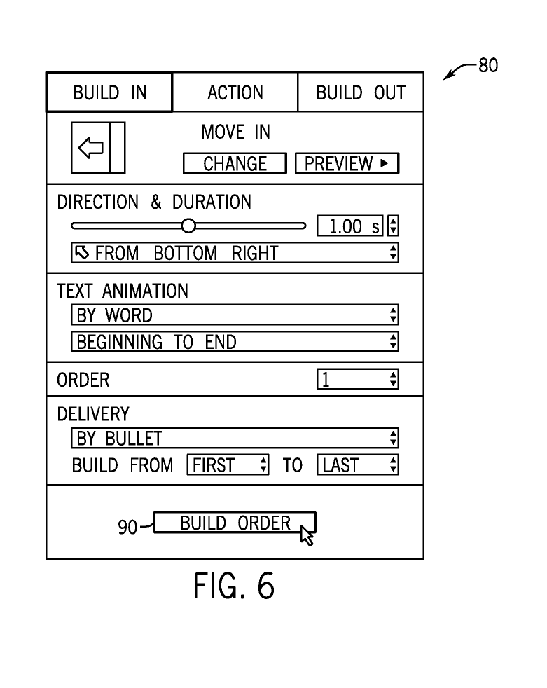

By way of example, and turning to FIG. 6, an example of a build inspector window 80 is depicted that allows generation and editing of a build for an object 44. In this example, tabs at the top of the inspector window, i.e., Build In tab 82, Action tab 84, and Build Out tab 86 allow a user to navigate between the different effects to be applied to an object 44 as part of a build in, action, or build out portion of an object build. Within each tab, various other fields and controls allow a user to specify or modify the effects applied in the build as part of such a build in, build out, or action. For example in the case of an animation effect, the user may be able to specify a direction, speed, and duration of the animation, if applicable, as well as the type of animation and any configurable parameters associated with that type.

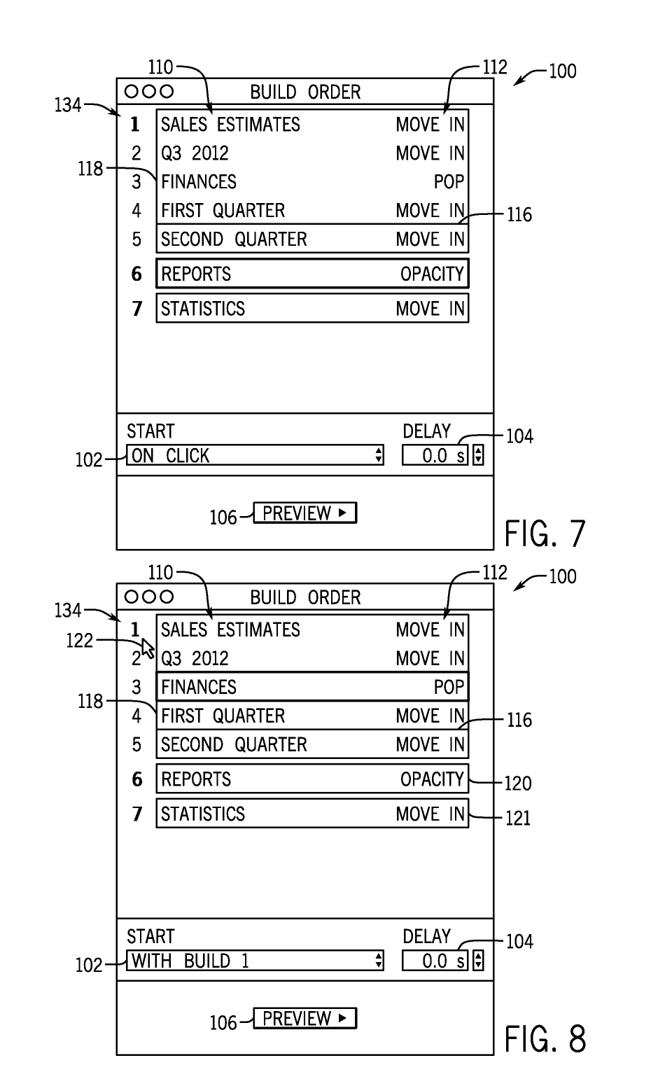

In addition, in the depicted build inspector window 80, an option (i.e., button 90) is provided that may allow a user to invoke a build order inspector panel 100 which may be used to specify or modify the order and manner in which build effects associated with the slide may be implemented when the slide is viewed. An example of one such build order inspector panel 100 is depicted in FIG. 7. In practice, the build order inspector panel may be displayed as an additional or replacement control window 46.

As depicted in this example of a build order inspector panel 100, the panel shows a list of build effects (i.e., a list of each build in, action, and build out effect) on the slide. In this example, the build effects (also referred to as build operations herein) are sequentially listed, such as a first build effect of “Move In” a “Sales Estimates” object, a second build effect of “Move In” a “Q3 2012” object, a third build effect of “Pop” a “Finances” object, and so forth. In the depicted implementation, each sequentially listed item includes an object descriptor 110 (e.g., “Sales Estimates”, “Q3 2012”, “Finances”, “First Quarter”, and so forth) and an effect label 112 (e.g., “Move In”, “Pop”, “Opacity”, and so forth). In the event that the number of build operations exceeds the provided display space, a scroll bar may also be provided on the side of the list of effects to allow a user to navigate the list.

In one implementation, a user may select a build operation, or a group of build operations, as discussed herein, such as using a mouse, keyboard or touch input. The selected build operation may be visually indicated, such as the sixth build operation (“Reports”) in the depicted example. More than one build operation may be selected at one time. Once one or more build operations are selected, a user may configure or modify those operations, such as by modifying one or more parameters associated with the selected operations.

For example, in the depicted example the build order panel 100 provides additional controls by which a user may configure one or more selected build operations, either individually or in a group. In the depicted example, a start drop down box 102 is provided so that, for a selected build operation or group of build operations, the user may specify what action causes the selected build operations to be performed, i.e., the start condition. Examples of actions that may cause the selected build operation to be performed include, but are not limited to, clicking a mouse button or keyboard key (such as the selected “On Click” of FIG. 7), being performed automatically upon a specified time limit expiring, i.e., based on a timer, relative to a defined event (such as the start or end of the preceding build or slide transition), being performed automatically after completion of a preceding build operation (i.e., “Build After”), being performed with a preceding build operation (i.e., “Build With”), or being performed automatically after a slide transition (i.e., “After Transition”).

For start conditions where the user specifies some time or elapsed time, a delay field 104 may also be provided where a user can configure the desired delay. For example, where the user specifies that a build operation be performed with or after a preceding operation in the build order list, the delay indicated in the delay field 104 may specify some delay between when the selected build operation begins relative to the start of the referenced preceding build operation (in the context of a “Build With” type start condition) or relative to the end of the referenced preceding build operation (in the context of a “Build After” type start condition). Likewise, for “After Transition” type stat conditions, a delay may be specified by the user such that the build operation having this start condition is performed after the specified delay from the time the slide transition is completed.

In addition, a preview button 106 (or comparable control) may be provided which, when selected, plays a preview of the selected build operation or group of build operations (as discussed below) in the order and manner specified in the build order panel 100. In this manner, a user may easily preview how a build operation or group of build operations will appear when displayed on the slide.

In one presently contemplated embodiment, a variety of additional build order information may also be provided in the build order inspector panel. For example, in the depicted implementation, build operations may be grouped, and the respective groupings of build operations visually depicted, such as by visually separating build operations in one group from those build operations in other groups. By way of example, in FIG. 7, build operations “1-5” are grouped into a first group 118, while build operations “6” and “7” are not grouped with the first group or with each other but instead constitute single effect groupings.

In addition, in this example information about which build operations are triggered by the selected start operation (e.g., “On Click”) may be visually conveyed in the build order list. By way of example, in the depicted implementation build operations “1”, “6”, and “7” are configured to trigger in response to a specified start condition, such as mouse or key click events (i.e., the first click event triggers operation “1”, the second click triggers operation “6”, and the third click triggers operation “7”). The numbers 134 associated with these build operations convey this information by being represented in plain, black numbers in the depicted example. Conversely, the other build operations in the first group (i.e., build operations “2-5”) are instead configured to occur with or after the build operation “1” (i.e., build operation “1” is the master or triggering effect). To visually convey this information, the build order numbers “2-4” are depicted in light or greyed out numbering. Hence, at a glance, a user can determine that build operations “2-4” occur with or after build operation “1”, with build operation “1” being the operation that is triggered by the specified start condition. As will be appreciated these joined or grouped build effects (e.g., build operations “1-5”) all occur in response to the specified start condition (such as a mouse or key click) and, in some implementations may be referred to as “click groups”.

Further, within a group, such as the first group of build operations “1-5”, a given build operation may be configured to occur with one or more other build operations within the group, or after the one or more other build operations within the group. This information may also be visually conveyed for a user to readily appreciate. For example, in the depicted implementation, build operation “5” is configured to occur after the preceding build operations are completed. This information is visually conveyed by the line separator 116, which in this example indicates that the actions below the line occur after the preceding actions above the line. Conversely, in this example, build operations “2-4” occur with one another and with the master or triggering build operation “1”, and therefore are not separated by a line separator 116.

In one implementation, the first effect or build operation in a group 118 (i.e., the master or trigger effect for the group) is set to have a start condition of “After Click”. An exception may be made for the first effect on the build order list, which may instead be set to “After Transition” so as to be automatically implemented upon completion of a slide transition. The other effects in the group 118 have their respective start conditions set to either build with (i.e., “With Build #”) or build after (“After Build #”) so that the respective build operation (i.e., effect) occurs with a preceding effect within the group 118 or automatically after completion of a preceding effect within the group 118. In one such example, the “#” references the preceding build operation in the build order list. As noted above, in FIG. 7, this distinction of being performed with or after the preceding build operation is visually conveyed by the present or absence of a line separator 116, with no line separator 116 conveying that a build operation occurs with the preceding build operation and a line separator 116 conveying that the build operation below the line occurs after completion of the preceding build operation.

As discussed herein, a single build operation or a group 118 of build operations may be reordered within the build order list panel 100 as a group, such as using a drag-and-drop approach. For example, turning to FIG. 8, a portion of a build order inspector panel 100 is depicted where the listed build operations include a first group 118 of build operations as well as two other groups 120, 121, each having only a single build operation. In one implementation, to reorder the group 118 of build operations relative to the other build operations in the build order list, the first number in the group 118 of build operations, here build operation “1”, is selected, as shown by pointer 122 in FIG. 8. In one embodiment, a visual indication, such as a highlight, may be provided around the edge of the group 118 to indicate that the group 118 has been selected.

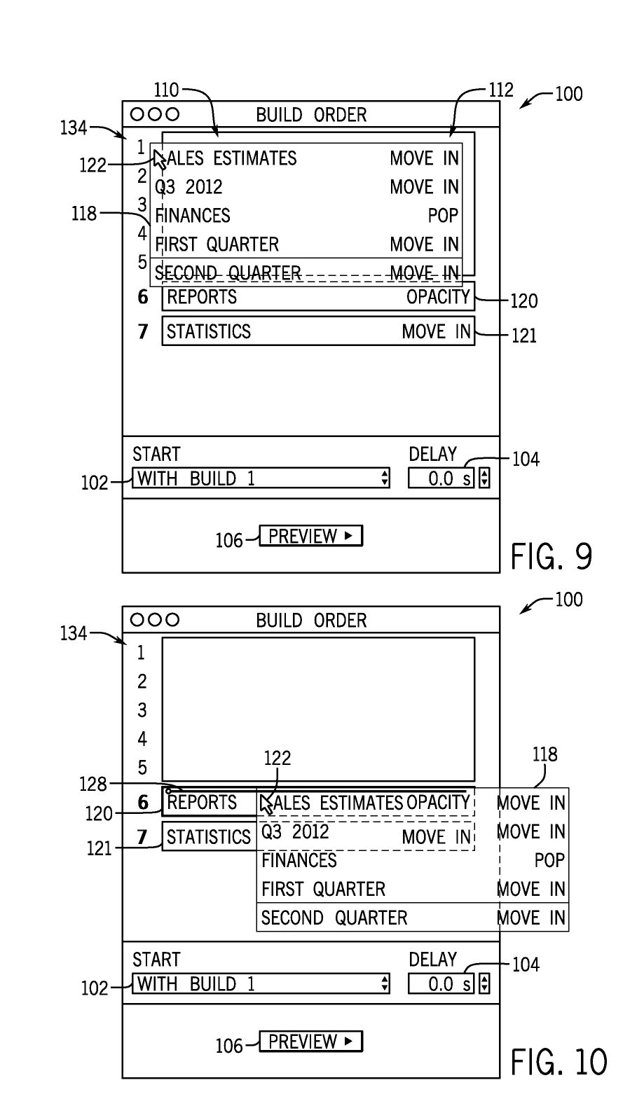

In one embodiment, once the group 118 is selected, such as by holding a mouse button down when the pointer 122 is positioned over the number 134 of the first build operation, the selected group 118 may be dragged to the desired position within the build order on the build order list panel 100. That is, a drag-and-drop type operation may be performed to reorder the group 118 within the build order list. For example, FIG. 9 depicts an implementation whereby the selected group 118 is detached from the build order list once selected to allow repositioning, i.e., dragging, of the group 118 build operations to a new position in the build order list. In one implementation, such as that depicted in FIGS. 9 and 10, the group 118 is visually depicted in a ghosted state when selected and when being moved and moves such that the upper left corner of the detached group moves with the pointer 122 as the pointer 122 is moved. Further, in the depicted example, the space in the build order list from which the selected group 118 is being moved, i.e., the region of the build order list from which the selected group 118 is detached, may be shown as blank or empty during the move operation.

In one embodiment, as the detached group 118 of build operations is moved over other groups of build operations or other single build operations, visual selection indicators, i.e., selection feedback, may be displayed for the user. For example, turning to FIG. 10, in the depicted implementation, once the pointer 122 is positioned over a location of the build order list panel 100 where the group 118 can be moved (e.g., dropped) a drop indicator 128 is displayed, here indicated as a line above the number “6” build operation “Reports”. Further, in the depicted example additional visual feedback of the proposed reposition or reorder of build operations may be evidenced by highlighting the boundary associated with group 120 to indicate that the build operations of group 118, if dropped at the current location, would be placed within the second group 120.

In this example, release of the detached group 118 being moved with the drop indicator in the depicted location would result in the first group 118 being added to the second group 120, with the effects (i.e., build operations), of the first group 118 being positioned above or before the single build operation (effect number “6”) of the second group 120. That is, an entire group of effects can be moved into a second group, with the drop indicator 128 visually indicating which group the effects will be moved into and where in the new group the moved effects will be placed in the build order.

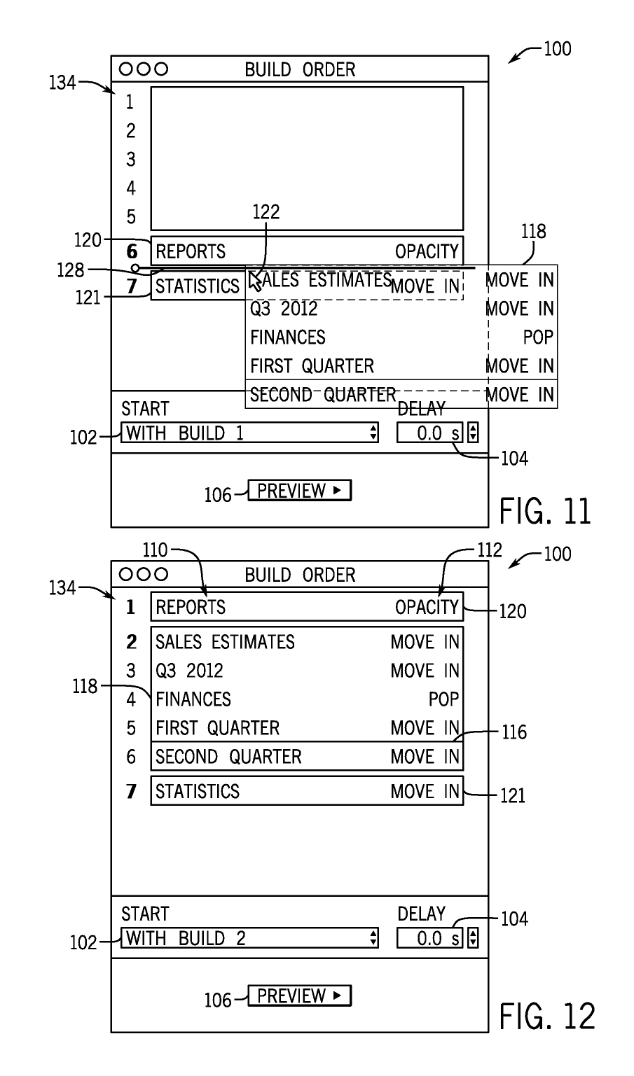

Turning to FIG. 11, in a further example, when the pointer 122 to which the detached group 118 of build operations being moved is positioned between other groups (here groups 120 and 121), the drop indicator 128 may visually differ from the previous example to indicate that the repositioning of group 118 would occur between existing group rather than within an existing group, thus providing the user with useful feedback. In particular, in this and the preceding example, the drop indicator 128 may be of different lengths depending on where the pointer 122 is located and where the group 118 being moved would be repositioned if dropped. In the example of FIG. 10, the drop indicator 128 is shorter and fits within the group 122 boundary to indicate that, if dropped, group 118 would be placed within the second group 120. Conversely, in FIG. 11, the drop indicator is longer (as long or longer than the edge of the boundary boxes defining the groups 120 and 121), indicating that, if dropped, group 118 would be placed between the second group 120 and the third group 121. Further, in the example of FIG. 11, no highlighting of the boundaries associated with groups 120 or 121 is provided because, in the depicted instance, pointer 122 is not positioned such that the build operations of group 118 would be added to either of these other groups.

Turning to FIG. 12, which continues the example of FIG. 11, the group 118 is released (i.e., “dropped”) to move group 118 into its new position within the build order list, i.e., beneath group 120. In this example, moving the group 118 changes the ordering (denoted by number 134) of the listed effects, causing automatic reordering of the numbering 134. That is, as a result of the depicted moved, the “Reports” object descriptor 110 is reordered from number “6” to “1” due to all of the effects within group 118 being moved beneath the “Reports” build effect. Likewise, each effect within group 118 is incremented by one to reflect that there is now a build effect in the build order list above the effects within the group 118 (i.e., “Sales Estimates” is now numbered “2” instead of “1”; “Q3 2012” is now numbered “3” instead of “2”; and so forth). Likewise, the start conditions for renumbered effects “3-5” of group 118 may be updated to reflect that these effects start or run with renumbered effect “2” (instead of effect “1”). Similarly, renumbered effect “6” may have its start condition updated to reflect it will run after renumbered effect “5”.

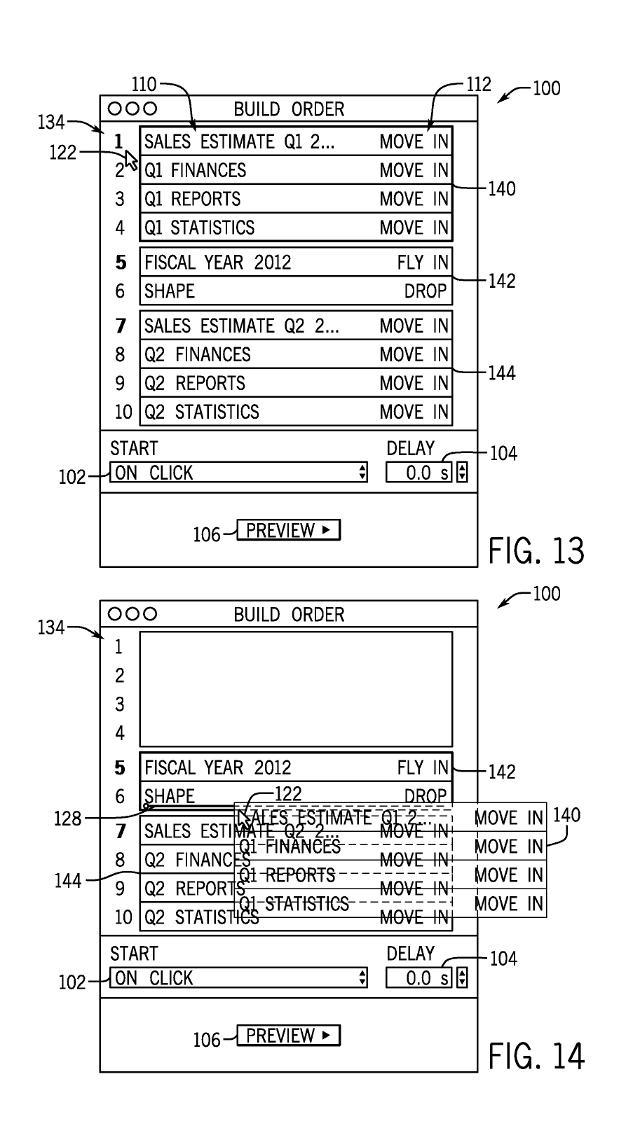

Turning to FIGS. 13-15, an additional example is provided. In this example a first group of build effects 140 is moved into a second group 142 of build effects where the second group 142 includes more than one listed build effect (i.e., effects “5” and “6”). As in the preceding examples, to initiate the move operation, the pointer 122 may be moved over a designated area associated with the first group 140, such as the number 134 of the first listed build effect within the group 140. Upon selection of the group 140 for reordering, such as by clicking and holding a mouse button while the pointer 122 is so positioned, a visual indication that the group 140 has been selected for reordering may be provided, such as by highlighting the boundary or border associated with the group 140.

In this example, and turning to FIG. 14, when the selected group 140 is moved for reordering, such as by dragging a mouse while holding down a mouse button, the group 140 may be visually ghosted (i.e., shown in a semi-transparent form) to allow a user to see both the build effects of the group 140 as well as the build order list being navigated. In the depicted example, a hole or space is visually indicated in the space from which group 118 has been moved, thereby providing the user with a visual reference as to where the effects of group 140 were previously associated, i.e., are being moved from.

As in previous examples, a drop indicator 128, here shown as a line, may be displayed to provide a user with visual feedback as to where in the build order the group 140 effects are currently positioned to be moved or inserted. In the depicted example, the drop indicator 128 is shown as indicating that the effects of group 140 would be inserted at the end of group 142 (i.e., after the “Shape” object descriptor numbered “6”). Because the move would be into another group, the drop indicator 128 may be shown shorted, so as to fit within the group boundary box, thereby visually conveying to the user that the move would be into an existing group of build effects.

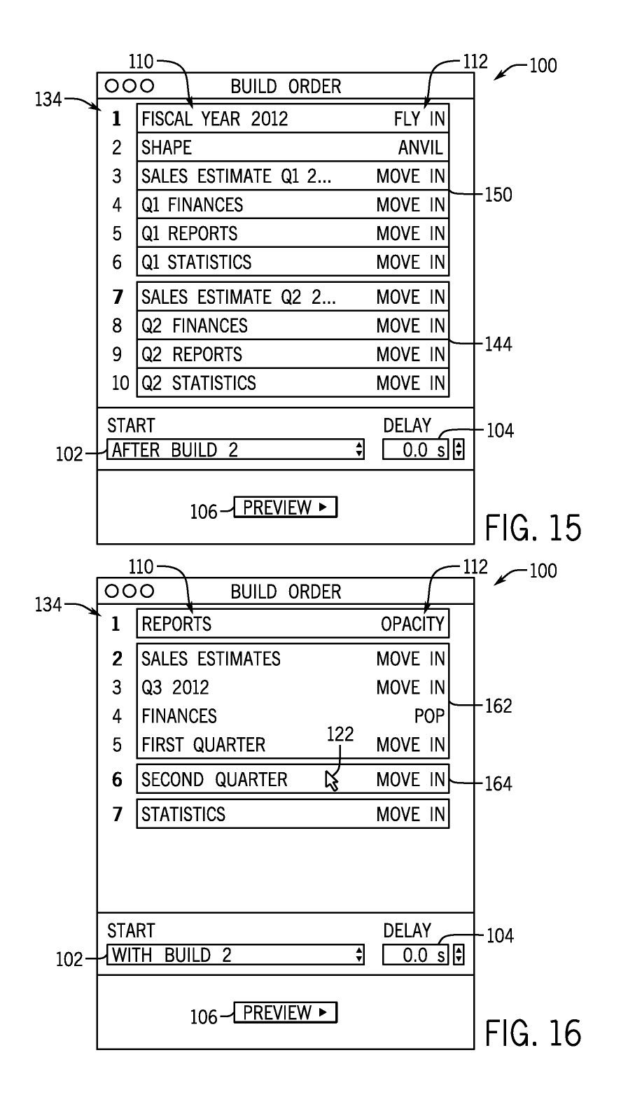

Once positioned, the user may release (i.e., drop) the group of effects being moved into their new position within the build order. Turning to FIG. 15, in this example, when the user reorders the effects of groups 140 and 142, placing the effects of group 140 at the end of group 142, a new, combined group 150 is created that includes all effects of previous groups 140 and 142. As depicted in FIG. 15, the effects may be automatically renumbered (numbers 134) to reflect the new order.

In addition, in this example effects which are initially configured to start in response to a user input (e.g., “On Click), here the build operation associated with “Sales Estimates Q1 2 . . . ”, renumbered to “3” from “1”, may automatically have their start condition changed to reflect their new order within the combined group 150. That is, the build operation for “Sales Estimates Q1 2 . . . ”, which was previously the master or trigger effect for group 140, is now subject to the build operation “Fiscal Year 2012”, which is renumbered to “1” from “5” and which is the master or trigger effect for the new combined group 150. As such, in this example, the build operation for “Sales Estimates Q1 2 . . . ” has had its start condition automatically changed to build after operation “2” from the previous “On Click” start condition. This change in start condition may be visually indicated to a user by the change in emphasis or color of the numbering 134 associated with the “Sales Estimates Q1 2 . . . ” build operation.

Similarly, turning to FIGS. 16-18, an example is provided in which a single build operation is moved into an existing group. Turning to FIG. 16, in this example the build operation 164 titled “Second Quarter” and initially numbered “6” is selected for reordering using the pointer 122, as discussed above. In this example, the operation 164 will be moved into the existing group 162 of build operations.

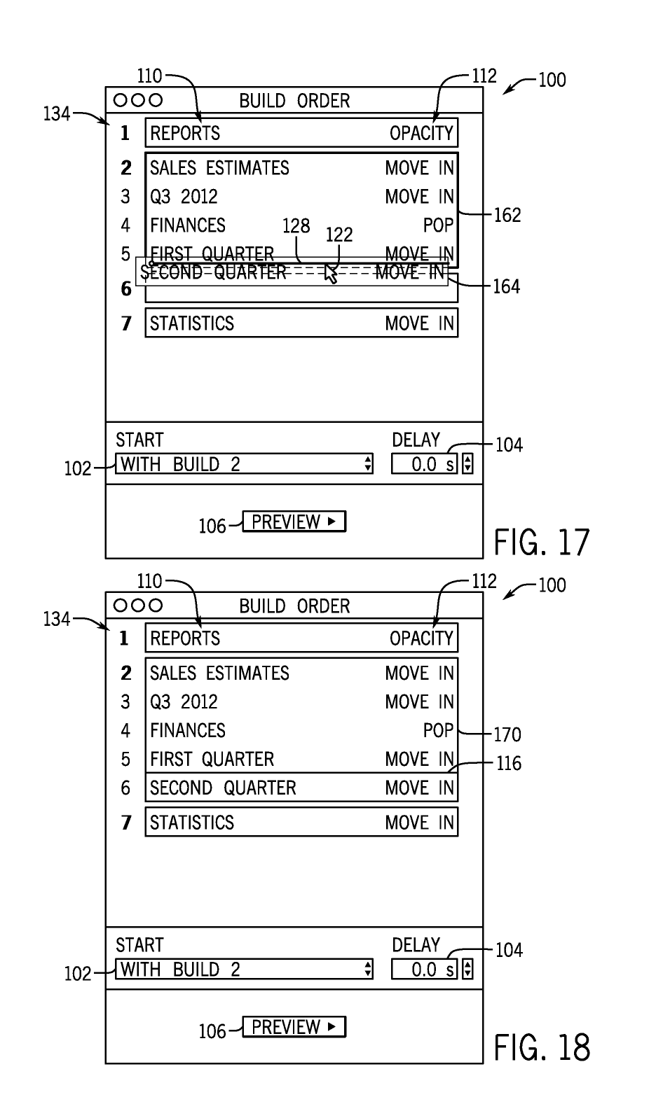

Turning to FIG. 17, in response to the user moving (i.e., dragging) the build operation 164 over the target group 162 of build operations, a drop indicator 128 may be displayed to provide visual feedback to the user as to the position within the group 162 where the build operation 164 is currently positioned for placement. As in previous examples, the drop indicator 128 may indicate by its length or by other visual cues whether the build operation 164 being reordered is situated to be placed in an existing grouping of build operations or between existing groupings of build operations. In addition, the target group 162 may also provide other visual indicators, such as a highlighted border or boundary, to visually provide feedback to the user that the build operation 164 is currently positioned to be inserted into the group 162.

Turning to FIG. 18, once positioned, the user may release (i.e., drop) the build operation 164 into its new position within the build order, i.e., at the end of the new combined group 170. In the depicted example, no reordering of the build operations occurs as the build operation 164 has simply been moved from being a stand-alone effect (i.e., a single effect within its own group) applied after the effects of group 162 to being the last effect listed in the new combined group 170.

In addition, in the depicted example the build operation 164, when added to the new combined group 170 has had its start condition changed from starting in response to a user input (e.g., “On Click) to having a “Build After” start condition, as denoted by line separator 116. That is, the build operation for “Second Quarter”, which was previously a stand-along build operation initiated by a user input, is now subject to the completion of the other build operations within the new, combined group 170. As such, in this example, the build operation for “Second Quarter” has had its start condition automatically changed as part of the reorder operation to build after operation “5” from the previous “On Click” start condition. This change in start condition may be visually indicated to a user by the change in emphasis or color of the numbering 134 associated with the “Second Quarter” build operation.

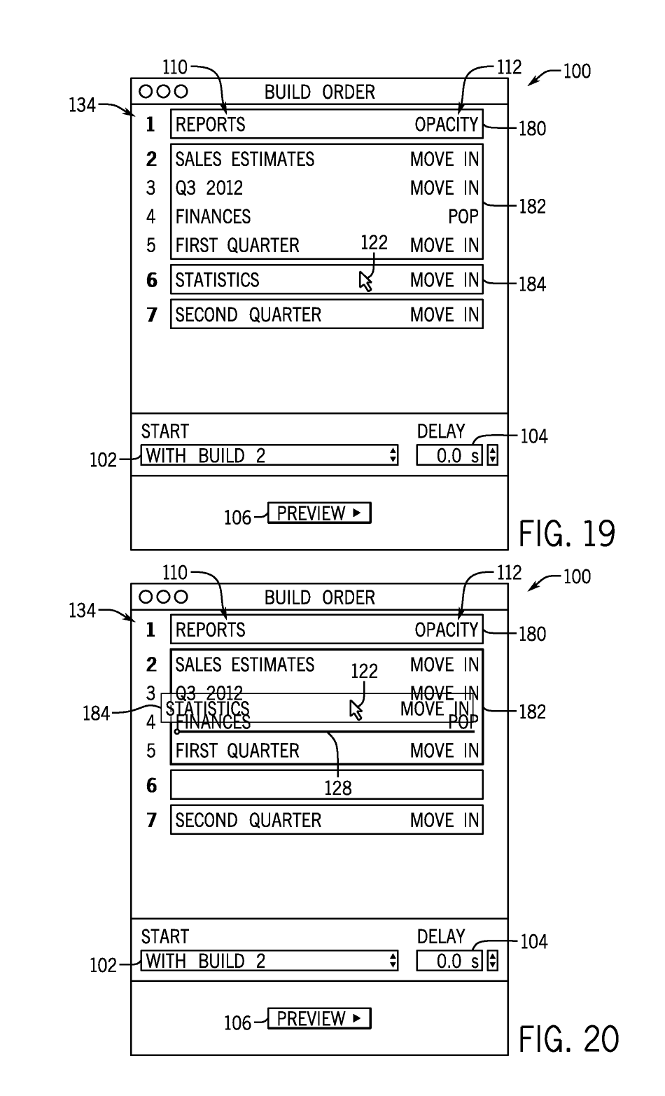

Turning to FIGS. 19-23, a further example is provided where a build operation 184 is moved to a new position in the build order between another build operation 180 and a group 182 of build operations. In this example, starting at FIG. 19, the build operation 184 is initially selected, such as using pointer 122. Once selected, and turning to FIG. 20, the build operation 184 may be moved (i.e., “dragged”) toward the new position in the build order.

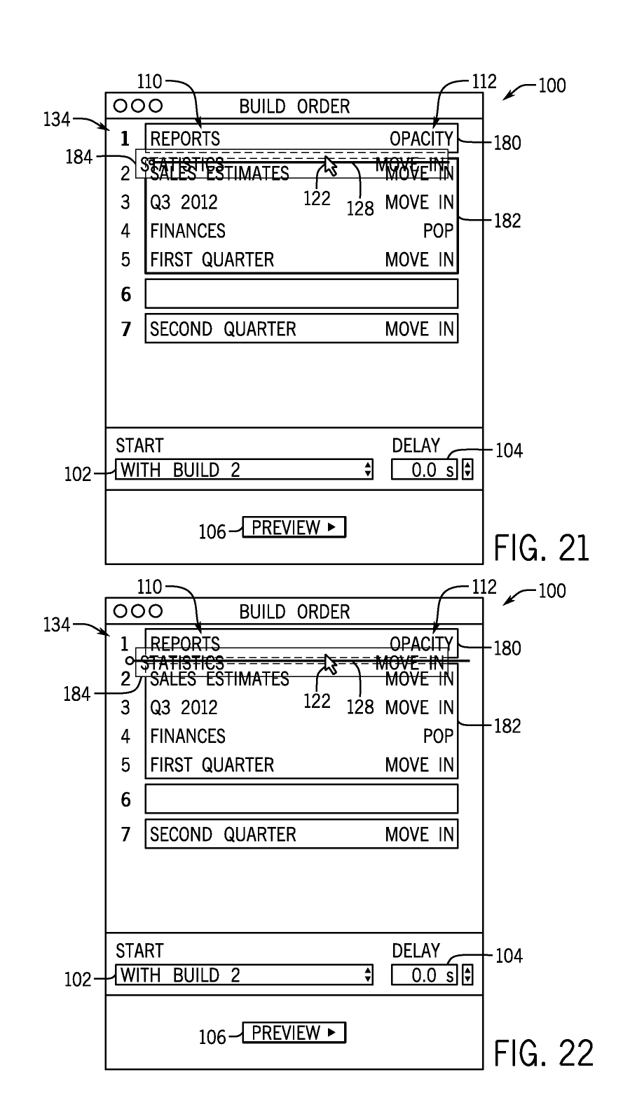

When moved in this manner, as in previous examples, the build operation 184 may be made semi-transparent (i.e., ghosted) to allow a user to view the build operation 184 as well as the underlying build order. As the build operation 184 is moved, visual feedback is provide to the user, such as drop indicator 122 which, when the build operation 184 is positioned to be dropped into the group 182 has a first configuration (e.g., length) signifying this position with respect to the group 182, as depicted in FIGS. 20 and 21 where the build operation 184 is seen being dragged across the group 182.

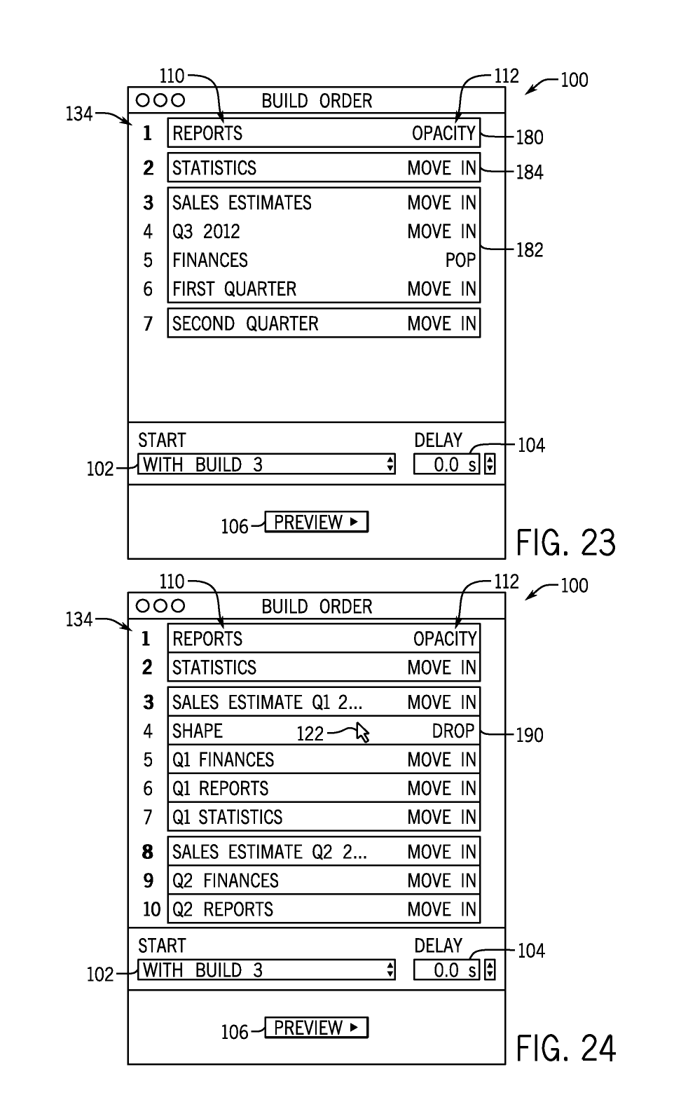

Turning to FIG. 22, as the build operation 184 is positioned between build operation 180 and group 182, the drop indicator 128 is visibly displayed between the build operation 180 and group 182 and is shown to have a different, longer configuration than when positioned over another group or build operation. In this manner, the user maybe provided feedback as to whether the build operation 184 being moved is in position to be added to a group or existing build operation or is in position to be dropped as a stand-alone group or operation. Turning to FIG. 23, the build operation 184 is shown after repositioning in the build order between build operation 180 and group 184. In response to this reordering of the build order list, the numbers 134 are updated to reflect the new order, with the build operation 184 preceding the group 182 of build operations.

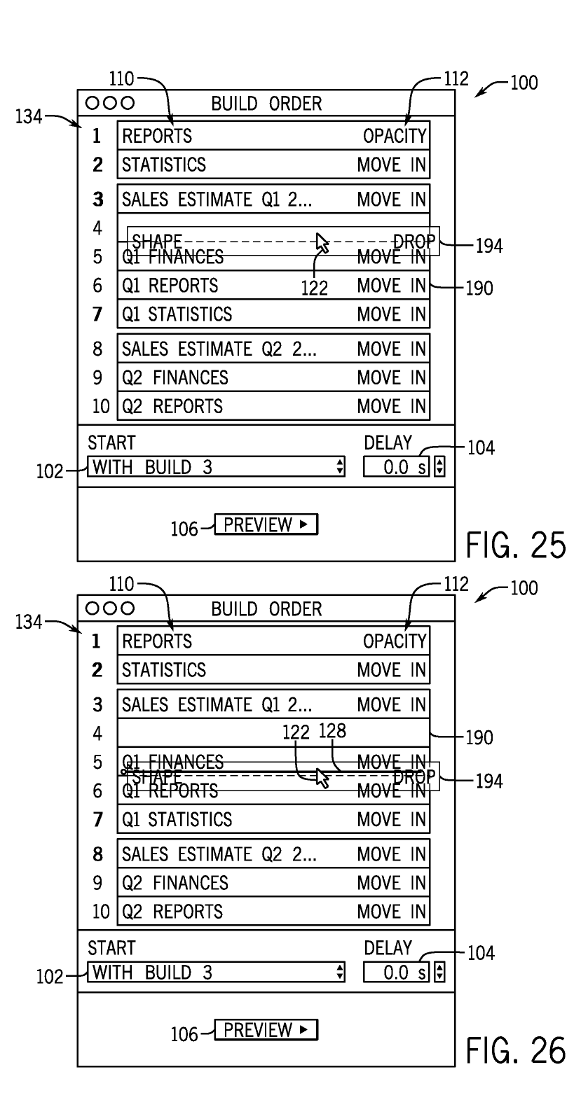

In a further example, FIGS. 24-28 depicts an operation whereby a build operation may be extracted from an existing group 190 of build operations. Turning to FIG. 24, in this example, the pointer 122 may be positioned over the effect to be moved (here, the “Shape” effect initially numbered “4”) and used to select this effect, scuh as by pressing and holding a mouse button. Turning to FIG. 25, the user may move (i.e., drag) the selected build operation 194, which may be depicted as leaving a space or hole in the group 194 while the extraction operation is performed.

As depicted in FIG. 26, while over the group 190, the build operation being moved may instead be reordered within the group 190, as indicated by the drop indication 128. Thus, if dropped at a new position within the group 190, the build operation 194 may simply be reordered within the group.

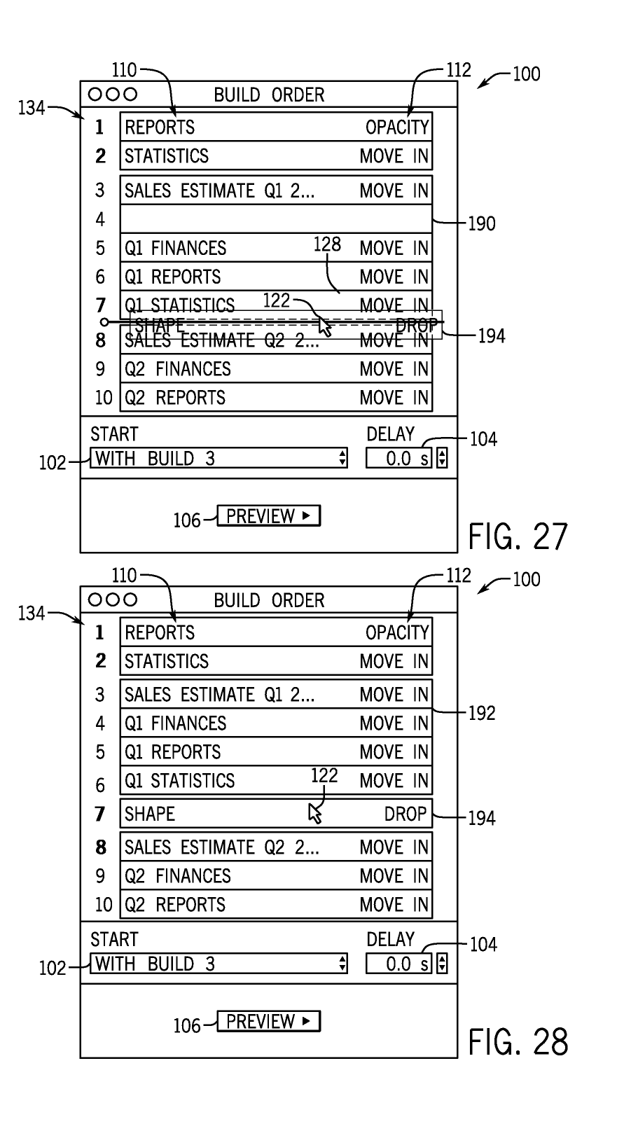

Alternatively, turning to FIG. 27, if the build operation 194 is dragged beyond the boundary of the group 190, the drop indicator may change (i.e., be lengthened) to indicate that the build operation 190 is no longer positioned to be dropped within a group. The drop indicator 128 provided visual user feedback allowing the user to position the build operation 194, in this example, outside of the group 190 upon release (i.e., drop). Turning to FIG. 28, upon release of the build operation 194, the build list is reordered, with the build operation 194 now a stand-alone build effect within the list after the new group 192 of build operations, which is simply the previous group 190 with the build operation 194 removed. As in previous examples, the build order list may be automatically renumbered upon completion of the move.

In this example also it is worth noting that a property of the build operation 194, the start condition, is changed automatically as part of the reorder operation. In particular, the build operation 194 initially has a “build with” start condition when part of the group 190. However, upon completion of the reorder operation, the start condition of the build operation 194, which is now a single effect within its own group, is automatically changed to start in response to a user input (i.e., “On Click”). AS will be appreciated, in other examples, the build operation 194, instead of being moved to its own single effect group, could instead have been moved to a different group of build operations, where it would have been handled as discussed above.

While the preceding example, demonstrated the extraction of a build operation from an existing group, it should be appreciated that the build operation within the group may instead have been moved within the group by the same mechanism, which may lead to build operations properties being changed within the group itself. For example, the build operation 190 could instead have been upward or downward in the sequence of effects for group 190. As discussed herein, such movement within the group may also lead to automatic changes to build operation properties. For example, movement of the build operation to be the first listed operation in the group 190 would result in the start condition for the “Shape” effect being automatically changed to “On Click”. That is, the moved build operation would become the master operation for the group 190 in this example. In addition, in this example, the start condition of the displaced build operation (here the “Sales Estimate Q12 . . . ” effect), would be automatically changed from “On Click” to “Build With” or “Build After” the new master build effect. Similarly, if the first build operation (i.e., the master effect) within the group 190 (here the “Sales Estimate Q12 . . . ” effect) were moved (either within the group 190 or out of the group 190), the previously second build operation in the group would become the new master effect and would automatically have its start condition changed to “On Click”, as discussed above. Further, as discussed in preceding examples, the build operations within the group 190 would be automatically renumbered in the event of such a move made within the group.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A processor-implemented method for reordering a build order list, comprising:
in response to a first user input, displaying a build order list on a display of an electronic device, wherein the build order list displays a sequence of build effects to be applied on a slide of a slideshow presentation;
receiving a second user input selecting a group of build effects from the build order list;
receiving a third input moving the group of build effects within the build order list;
displaying a drop indicator as the group of build effects is moved within the build order list, wherein the drop indicator conveys at least information about where the group of build effects would be positioned in the build order list at a given time; and
receiving a fourth user input placing the group of build effects at a new location in the build order list, wherein upon placement of the group of build effects at the new location, at least one property of one or more of the build effects of the group is changed.

2. The processor-implemented method of claim 1, wherein the drop indicator is visually varied based on whether the group of build effects is positioned to be added to a second group of one or more build effects or not.

3. The processor-implemented method of claim 2, wherein the drop indicator is visually varied by showing the drop indicator at a first length when overlying the second group of one or more build effects and by showing the drop indicator at a second length when not overlying another group of build effects.

4. The processor-implemented method of claim 1, wherein the at least one property of the one or more build effects of the group that is changed is a start condition.

5. The processor-implemented method of claim 1, comprising showing the group of build effects in a semitransparent state when the group of build effects is being moved.

6. The processor-implemented method of claim 1, wherein the group of build effects is displayed with one or more visual indicators to that indicate a start condition for one or more of the build effects of the group.

7. A non-transitory, tangible computer-readable medium encoding processor-executable routines, wherein the routines, when executed by a processor cause acts to be performed comprising:
visually detaching a selected group of build effects from a displayed build order list in response to a user selection;
moving the visually detached group of build effects relative to the build order list in response to a user input;
displaying a visual indicator corresponding to a current drop position of the group of build effects as the group of build effects is moved relative to the build order list;
repositioning the group of build effects within the build order list upon receiving a user drop command; and
concurrent with repositioning the group of build effects within the build order list, changing a property of one or more of the build effects within the group or one or more build effects affected by the repositioning of the group.

8. The non-transitory, tangible computer-readable medium of claim 7, wherein the routines, when executed by the processor cause further acts to be performed comprising:
changing a transparency of the group of build effects when visually detached.

9. The non-transitory, tangible computer-readable medium of claim 7, wherein the routines, when executed by the processor cause further acts to be performed comprising:
automatically renumbering the build order list after repositioning the group of build effects.

10. The non-transitory, tangible computer-readable medium of claim 7, wherein a length of the visual indicator is varied depending on where over the build order list the group of build effects is being moved.

11. The non-transitory, tangible computer-readable medium of claim 7, wherein changing the property comprises changing a start condition of one or more build effects.

12. A processor-implemented method for reordering a build order list, comprising:
displaying a build sequence on a display of an electronic device, wherein the build sequence comprises a plurality of build operations to be applied on a slide of a slideshow presentation;
displaying a group of build operations detached from the build sequence when the group is selected for reordering, wherein the group comprises a master operation is configured to start in response to receiving a user input and wherein the group comprises one or more additional build operations configured start with or after the master operation;
showing a drop indicator when the group is moved relative to the build sequence;
upon receipt of a drop indication, repositioning the group of build operations within the build sequence and automatically reordering the build sequence; and
concurrent with repositioning the group of build operations within the build sequence, automatically changing a start property of one or more build operations within the build sequence based on the reordered build sequence.

13. The processor-implemented method of claim 12, wherein the group of build operations is visually detached so as to leave an empty space in the build sequence.

14. The processor-implemented method of claim 12, wherein the one or more additional operations that are configured to start after the master operation are visually separated from the remainder of the group by a line separator.

15. The processor-implemented method of claim 12, further comprising:
displaying a number for each build operation of the build sequence, wherein the numbers are displayed differently for one or more different start properties.

16. The processor-implemented method of claim 12, wherein the drop indicator visually conveys information about both the position of potential drop event and whether the potential drop event would be into a second group of one or more build operations in the build sequence.

17. A non-transitory, tangible computer-readable medium encoding processor-executable routines, wherein the routines, when executed by a processor cause acts to be performed comprising:
displaying a build order of a plurality of build operations to be performed on a slide of a slideshow, wherein at least some of the build operations are grouped together into one or more groups that are each initiated by a single user input;
receiving a drag-and-drop command to reposition a selected group within the build order;
displaying a drop indicator during the drag-and-drop command that provides visual feedback as to where in the build order the selected group is currently positioned to be dropped; and
automatically reordering the build order upon completion of the drag-and-drop command; and
upon completion of the drag-and-drop command, automatically changing a start property of one or more of the build operations within the build sequence.

18. The non-transitory, tangible computer-readable medium of claim 17, wherein the single user input is a mouse click, so that each group of build operations is initiated by a respective mouse click.

19. The non-transitory, tangible computer-readable medium of claim 17, wherein visual indicator varies in length based on location over the build order.

20. The non-transitory, tangible computer-readable medium of claim 17, wherein the routines, when executed by the processor cause further acts to be performed comprising:
showing the selected group in a ghosted state during the drag-and-drop command.

21. A processor-based system, comprising:
a display;
a memory storing one or more routines; and
a processing component configured to execute the one or more routines stored in the memory, wherein the one or more routines, when executed by the processing component, cause acts to be performed comprising:
within an edit mode of a presentation application, editing a build order of a slide of a slideshow presentation by:
moving a group of build effects within the build order in response to a drag-and-drop command performed on the group;
displaying visual feedback while moving the group of build effects showing at least a present drop location for the group and; and
upon completion of the drag-and-drop command, automatically changing at least one property of a build effect based upon a new order for the build effects.

22. The processor based system of claim 21, wherein the displayed visual feedback also provides an indication as to whether one or more start conditions for one or more build effects will be changed if the group of build effects where to dropped at the present drop location.

23. The processor based system of claim 21, wherein the group of build effects is displayed in a semitransparent state when moving.

24. The processor based system of claim 21, wherein editing a build order further comprises:
automatically reordering the build order upon completion of the drag-and-drop command.
